(19) United States
(12) Patent Application Publication
(10) Pub. No.: US 2026/0230592 A1
(43) Pub. Date: Aug. 6, 2026

(54) PROJECTION DEVICE AND METHOD FOR CONTROLLING PROJECTION DEVICE

(71) Applicant: SEIKO EPSON CORPORATION, Tokyo (JP)

(72) Inventor: Yoshihiro JINBO, OITA-SHI (JP)

(21) Appl. No.: 19/463,668

(22) Filed: Jan. 29, 2026

(30) Foreign Application Priority Data
Jan. 31, 2025 (JP) 2025-014792

(51) Int. Cl. H04N 9/31

(52) U.S. Cl. CPC H04N 9/3185; H04N 9/3176; H04N 9/3194

(57) ABSTRACT

A projection device includes: a projector configured to project an image on a projection surface; a housing configured to accommodate at least a part of the projector; a sensor configured to detect a movement or stop of the housing; and one or a plurality of processors, and the one or plurality of processors cause the projector to project a notification image notifying that processing of geometric correction on the image is not finished, when it is determined that the housing is moving, based on a result of detection by the sensor.

The present application is based on, and claims priority from JP Application Serial Number 2025-014792, filed January 31, 2025, the disclosure of which is hereby incorporated by reference herein in its entirety.

### BACKGROUND

### 1. Technical Field

The present disclosure relates to a projection device and a method for controlling a projection device.

### 2. Related Art

According to the related art, as disclosed in JP-A-2010-109585, there is known an device that cancels processing of correcting a keystone distortion and projects a guide pattern so that the user can install the device horizontally, when the start of movement is detected.

JP-A-2010-109585 is an example of the related art.

However, with the above-described device, it is difficult for the user to grasp the state of the keystone distortion correction processing simply by viewing the guide pattern, and this may be inconvenient.

### SUMMARY

According to an aspect of the present disclosure, a projection device includes: a projector configured to project an image on a projection surface; a housing configured to accommodate at least a part of the projector; a sensor configured to detect a movement or stop of the housing; and one or a plurality of processors, and the one or plurality of processors cause the projector to project a notification image notifying that processing of geometric correction on the image is not finished, when it is determined that the housing is moving, based on a result of detection by the sensor.

According to another aspect of the present disclosure, a method for controlling a projection device including a projector configured to project an image on a projection surface, a housing configured to accommodate at least a part of the projector, a sensor configured to detect a movement or stop of the housing, and one or a plurality of processors, is provided, and the method includes causing, by the one or plurality of processors, the projector to project a notification image notifying that processing of geometric correction on the image is not finished, when it is determined that the housing is moving, based on a result of detection by the sensor.

### BRIEF DESCRIPTION OF THE DRAWINGS

FIG. 1 is a schematic diagram showing a projection device that projects a projection image onto a projection surface.

FIG. 2 is a block diagram illustrating the configuration of the projection device.

FIG. 3 is a block diagram showing the configuration of a projector.

FIG. 4 is a flowchart showing the control of the projection device.

FIG. 5 is a schematic diagram when a notification image is projected on the projection surface.

FIG. 6 is a schematic diagram when a correction image is projected on the projection surface.

### DESCRIPTION OF EMBODIMENTS

Hereinafter, embodiments will be described with reference to the drawings. Note that directions in the drawings are described, using a three-dimensional coordinate system. For the sake of convenience of description, a positive direction on a Z axis is referred to as an upward direction or simply as above, a negative direction thereon is referred to as a downward direction or simply as below, a positive direction on an X axis is referred to as a rightward direction or simply as right, a negative direction thereon is referred to as a leftward direction or simply as left, a positive direction on a Y axis is referred to as a rearward direction or simply as rear, and a negative direction thereon is referred to as a forward direction or simply as front.

### 1. Configuration of Projection Device

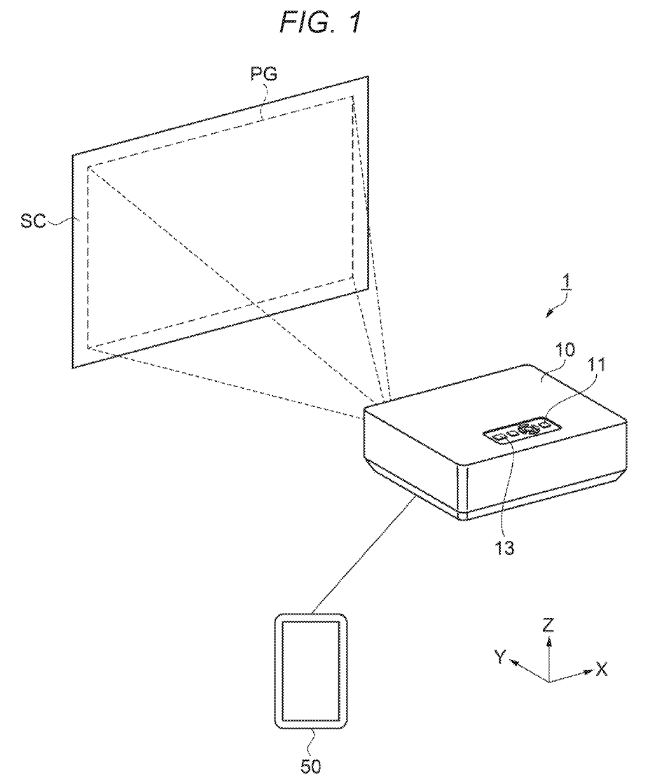

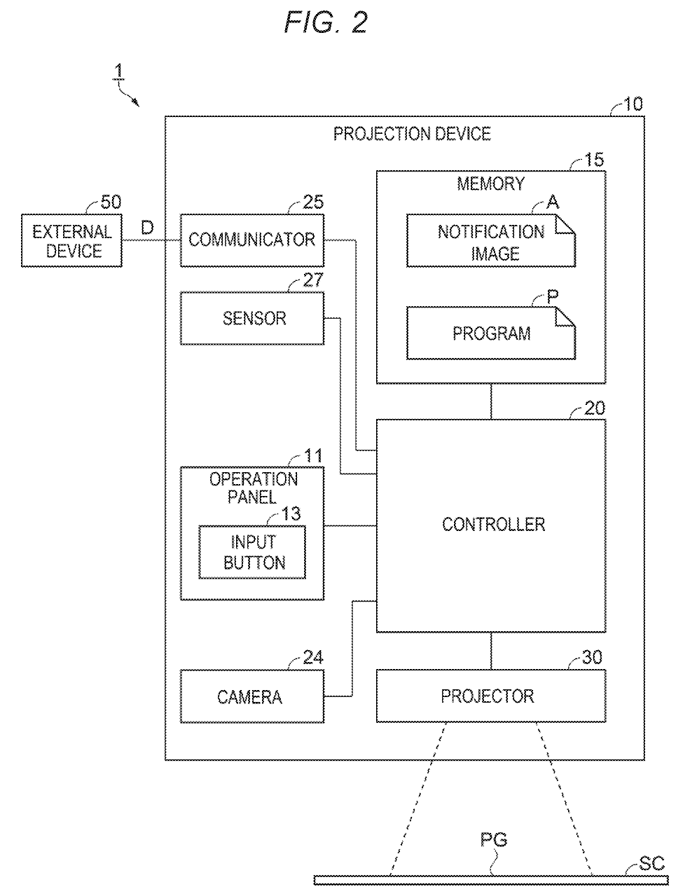

As shown in FIGS. 1 and 2, a projection device 1 includes a housing 10, an operation panel 11, a memory 15, a controller 20, a communicator 25, a camera 24, a sensor 27, and a projector 30.

The housing 10 accommodates the memory 15, the controller 20, the communicator 25, and the sensor 27, and accommodates at least a part of the projector 30. The operation panel 11 is installed at an upper part of the housing 10.

As will be described later, the projector 30 of the projection device 1 can project image data and the like stored in the memory 15 onto a projection surface SC on the rear side as a projection image PG under the control of the controller 20. The projection surface SC is a screen, a wall, or the like. The projection is also referred to as image/video projection, video projection, or image projection.

The controller 20 comprehensively controls the elements of the projection device 1. The controller 20 includes one or a plurality of CPUs (central processing units), a UART (universal asynchronous receiver-transmitter) that manages inputs and outputs, and an FPGA (field-programmable gate array) and a PLD (programmable logic device), which are logic circuits, and the like. The controller 20 is also referred to as a processor. The CPU of the controller 20 may be particularly referred to as a processor. The controller 20 can include one processor or a plurality of processors corresponding to functions to be processed, respectively.

The memory 15 includes a flash ROM (read-only memory) and an HDD (hard disk drive), which are rewritable nonvolatile memories, and a RAM (random-access memory), which is a volatile memory. The nonvolatile memory of the memory 15 may include an SSD (solid-state drive).

The CPU of the controller 20 reads a program P such as firmware stored in the nonvolatile memory of the memory 15 and executes the program P, using the volatile memory as a work area.

Various types of image data are stored in the memory 15. Hereinafter, the image data is also simply referred to as an image. The memory 15 stores a notification image A, which is notification image data. As will be described later, the memory 15 also stores a content image D, which is content image data, a projection image PG, which is projection image data, a correction image C, which is correction image data, and the like.

The communicator 25 includes a circuit that can communicate wirelessly or via a wire. The communicator 25 includes an antenna when performing wireless communication, and includes a connector when performing communication via a wire.

The communicator 25 can communicate with an external device 50, which is an image supply device such as a computer or a DVD player. The communicator 25 can receive the content image D from the external device 50. The content image D received by the communicator 25 is stored in the memory 15.

The projection device 1 includes the operation panel 11. The operation panel 11 includes a plurality of input buttons 13. The user operates the input buttons 13 of the operation panel 11 to configure various settings and give various instructions of the projection device 1. The operation panel 11 may be a touch panel display including an inputter and an outputter.

The operation panel 11 can accept an operation of setting the type of language by the user. The controller 20 can change the content of the character string of each of a first message AM included in the notification image A and a second message CM included in the correction image C, which will be described later, according to the type of language set by the operation of the user.

The sensor 27 is fixed to the housing 10. The sensor 27 outputs a detection value corresponding to the movement of the housing 10. As the sensor 27, for example, a velocity sensor, an angular velocity sensor, an acceleration sensor, an inclination sensor, or the like can be used. The sensor 27 is, for example, a gyro sensor. The controller 20 can acquire a detection value from the sensor 27 and detect the movement or stop of the housing 10.

The controller 20 includes a timer (not illustrated), and can also calculate the speed at which the housing 10 moves, based on the detection value of the sensor 27 acquired at predetermined time intervals. For example, the controller 20 can calculate a first speed at which the housing 10 moves, a second speed faster than the first speed, and the like, using the sensor 27.

Also, the controller 20 may pick up, with the camera 24, the projection image PG, the notification image A, or the like, which will be described later, projected onto the projection surface SC, at predetermined time intervals, and determine whether the housing 10 is moving or stopped, based on whether there is a change in the image. In this case, the sensor 27 may not be used.

The controller 20 may detect whether there is a change in the distance between the housing 10 and the projection surface SC, using a time-of-flight (TOF) sensor, and determine whether the housing 10 is moving or stopped.

The camera 24 includes an image sensor such as a charge-coupled device (CCD). The camera 24 can pick up the projection image PG and the like projected on the projection surface SC.

The controller 20 can acquire a picked-up image picked up by the camera 24 and detect the inclination of the projection device 1 in relation to the projection surface SC, the posture of the projection device 1, the image shape of the projection image PG, the distance between the projection device 1 and the projection surface SC, the facing angle of the projection device 1 to the projection surface SC, the projection surface shape of the projection surface SC, and the like. The facing angle is the angle between the optical axis of the light projected by the projection device 1 and the projection surface SC.

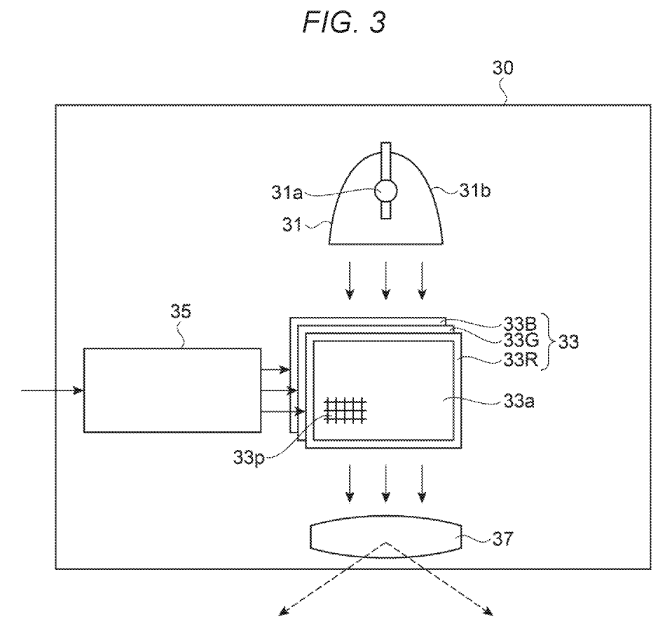

Next, the projector 30 will be described in detail with reference to FIG. 3. The projector 30 includes a light source 31, a liquid crystal light valve 33, a light valve driver 35, and a projection lens 37.

The light source 31 includes a light emitter 31a, a reflector 31b, an optical integration system (not shown), and a color separation system (not shown). The light source 31 emits light to the liquid crystal light valve 33 under the control of the controller 20.

The light emitter 31a is a xenon lamp, an ultra-high-pressure mercury lamp, an LED, a laser light source, or the like. The reflector 31b reduces variations in the direction of emission of the light emitted by the light emitter 31a. The optical integration system reduces variations in the luminance distribution of the light emitted from the light source 31. The color separation system separates the light having passed through the reflector 31b into red, green, and blue color light components.

The liquid crystal light valve 33 modulates the light emitted from the light source 31. By modulating the light, the liquid crystal light valve 33 generates the projection image PG or the like, which is an image to be projected.

The liquid crystal light valve 33 is formed of a liquid crystal panel made up of a pair of transparent substrates with liquid crystal enclosed therebetween. A rectangular pixel area 33a including a plurality of pixels 33p arranged in the form of a matrix is formed in the liquid crystal light valve 33. In the liquid crystal light valve 33, a drive voltage is applied to each pixel 33p.

The liquid crystal light valve 33 includes three liquid crystal light valves, that is, a red-light liquid crystal light valve 33R, a green-light liquid crystal light valve 33G, and a blue-light liquid crystal light valve 33B.

A red color light component separated by the color separation system becomes incident on the red-light liquid crystal light valve 33R. A green color light component separated by the color separation system becomes incident on the green-light liquid crystal light valve 33G. A blue color light component separated by the color separation system becomes incident on the blue-light liquid crystal light valve 33B.

The light valve driver 35 is coupled to the controller 20 and applies a drive voltage to each pixel 33p, based on image data corresponding to the projection image PG or the like, under the control of the controller 20. When the light valve driver 35 applies a drive voltage to each pixel 33p, each pixel 33p is set to a light transmittance based on the image data. The drive voltage is supplied by a power supply (not shown).

The light emitted from the light source 31 is transmitted through the pixel area 33a and thus modulated. The red-light liquid crystal light valve 33R, the green-light liquid crystal light valve 33G, and the blue-light liquid crystal light valve 33B form color component images for the respective color lights.

The element that modulates light may not be the liquid crystal light valve 33. For example, a transmissive liquid crystal panel, a reflective liquid crystal panel, a digital micromirror device or the like may be used.

The projection lens 37 combines the color component images formed by the liquid crystal light valves 33 and projects the combined image in an enlarged manner. The projection lens 37 projects the projection image PG or the like onto the projection surface SC. The projection image PG or the like projected on the projection surface SC is an image formed by combining the color component images.

### 2. Method for Controlling Projection Device

Hereinafter, it is assumed that images to be projected by the projection device 1 are stored in the memory 15, each as a single image, or as a combination of a plurality of images. Also, the execution of a series of processes in which the controller 20 reads one image from the memory 15 and projects the image onto the projection surface SC by the projector 30 as described above will be omitted.

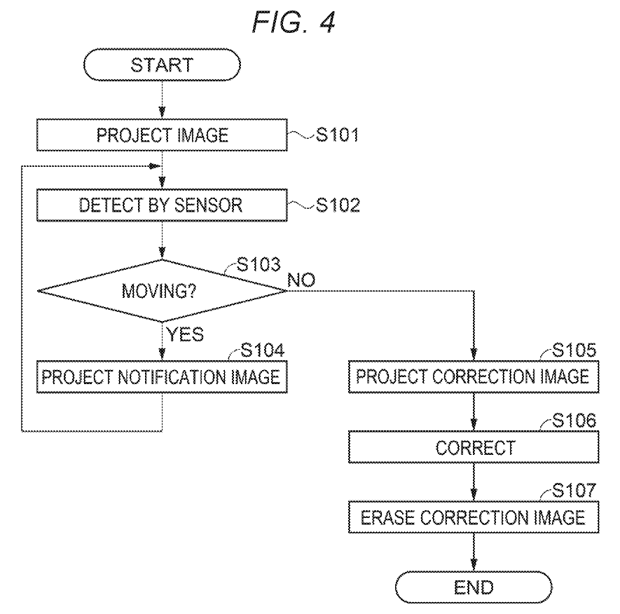

As shown in FIG. 4, the controller 20 starts the processing and projects, for example, an image such as the projection image PG based on the content image D onto the projection surface SC in (S101).

At this time, depending on the relative positional relationship between the housing 10 of the projection device 1 and the projection surface SC, a geometric distortion may occur in the projection image PG projected on the projection surface SC. For example, a so-called keystone distortion may occur, in which the projected projection image PG, which originally should be rectangular, is trapezoidal. The keystone distortion is an example of the geometric distortion.

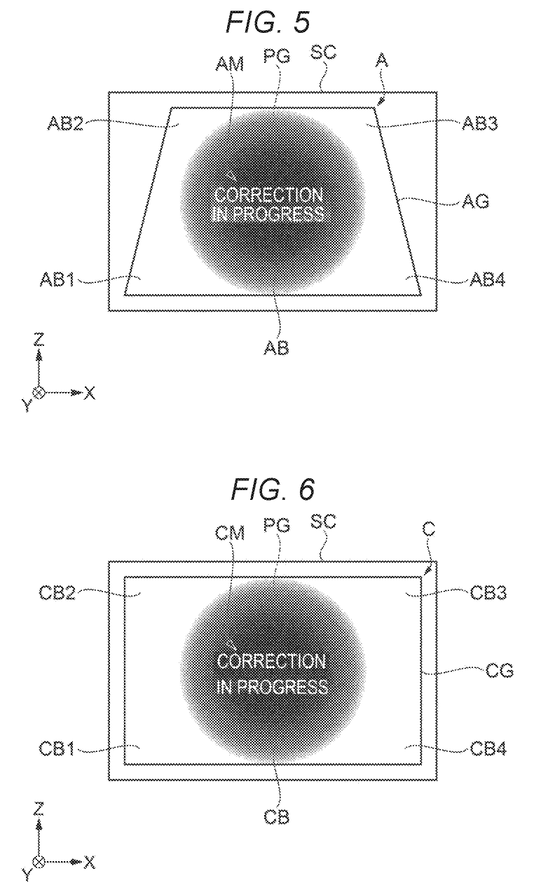

For example, it is assumed that the housing 10 is installed in a posture inclined downward at a predetermined angle with respect to the projection surface SC. In this case, as shown in FIG. 5, the contour of the projection image PG projected on the projection surface SC has a keystone distortion such that the contour is in a trapezoidal shape with a short upper side and a long lower side.

The user may move the housing 10 of the projection device 1 in relation to the projection surface SC in order to correct the keystone distortion of the projection image PG.

The controller 20 detects the movement state of the housing 10 by the sensor 27 (S102). The controller 20 acquires the detection value from the sensor 27 and determines whether the housing 10 is moving in (S103).

When the controller 20 determines that the housing 10 is moving, due to the detection value being equal to or greater than a predetermined value (YES in S103), the controller 20 projects the notification image A as illustrated in FIG. 5 (S104). The notification image A is also an image for the projection device 1 to notify the user.

The controller 20 may combine the projection image PG and the notification image A in the memory 15 and project the combined image.

For example, the controller 20 can superimpose the notification image A on the projection image PG subjected to the transmission processing, thus combine these images together, and project the combined image. At this time, the controller 20 may perform reduction processing for reducing the visibility of the projection image PG. Examples of the reduction processing include pixelization processing, luminance reduction processing, tone reduction processing, and the like. In the following description, reducing the visibility is also referred to as decreasing the visibility.

In this way, the controller 20 can perform the reduction processing of reducing the visibility on the projection image PG, which is a first image, to obtain a second image, and superimpose the notification image A on the second image.

The controller 20 may switch the target to be read from the memory 15 to the notification image A and project only the notification image A.

As shown in FIG. 5, similarly to the projection image PG, the notification image A, too, is projected in a distorted trapezoidal shape on the projection surface SC. The projection of the notification image A is also preprocessing for correction, described later, on the projection image PG by the controller 20.

As shown in FIG. 5, the notification image A projected on the projection surface SC includes a first message AM, which is a character string, a first guide pattern AG, which is a rectangular frame, and a first background image AB. Preferably, a single color is used for the first message AM and the first guide pattern AG.

The notification image A includes "correction in progress" of the first message AM, which is a character string notifying that the geometric correction processing is not finished.

The first message AM, the first guide pattern AG, and the first background image AB may be stored in the memory 15 as individual images and combined together as the notification image A by the controller 20.

The first message AM is preferably located at the center of the notification image A. The first guide pattern AG is preferably a rectangular frame including an area of a maximum range that can be projected by the projection device 1.

In the first background image AB, the gradation becomes darker and the tint is blurred toward the center of the notification image A, and the gradation becomes lighter and the tint is blurred toward four corners AB1 to AB4 of the first background image AB.

The four corners AB1 to AB4 are a lower left corner AB1, an upper left corner AB2, an upper right corner AB3, and a lower right corner AB4. The four corners AB1 to AB4 are also the four corners of the notification image A and are also the four corners of the first guide pattern AG.

The gradation may become lighter and the tint may be blurred toward the four sides of the first guide pattern AG representing a rectangle.

In this way, the brightness of the first background image AB of the notification image A increases continuously or in stages in the direction toward the periphery. In this case, the user is less likely to feel something is wrong than when the vicinity of the periphery of the first background image AB has an edge or the like.

The gradation of the first background image AB is, for example, of a color such as red, green, or blue, and a single color is preferably used. The gradation may be of a color using gray tone including white. The first background image AB may be white without using gradation.

The gradation or the like of a second background image CB of the correction image C, described later, can be similar to that of the first background image AB described above.

The first guide pattern AG of the notification image A, too, which should originally be projected as a rectangular frame, is projected in a distorted trapezoidal shape on the projection surface SC. When correcting the inclination of the housing 10, the user can use the first guide pattern AG of the notification image A projected on the projection surface SC as a guide. The user can move the housing 10 by attempting to make the first guide pattern AG have the original rectangular shape while viewing the first guide pattern AG.

In this way, the first message AM at the center of the notification image A has a clear contrast difference from the first background image AB having a dark gradation, and is easily visually recognized by the user. When the first background image AB is white, the first message AM may be black or colored. With the first message AM, the user can recognize that the projection device 1 is in the state of "correction in progress" on the keystone distortion.

As will be described later, when the controller 20 determines that the housing 10 is moving, the controller 20 does not correct the keystone distortion. The controller 20 starts the correction after the housing 10 stops.

In this way, when the controller 20 determines that the housing 10 is moving, based on the result of detection by the sensor 27, the controller 20 causes the projector 30 to project the notification image A notifying that the processing of the geometric correction on the projection image PG or the like is not finished.

Even at the preprocessing stage for the correction, described later, the user can visually recognize the projection of the notification image A and grasp that the state of the correction processing such as the geometric correction on the projection image PG is "correction in progress", which means that the processing is not finished, and this is convenient.

Meanwhile, when the controller 20 determines that the housing 10 is not moving and is stopped, due to the detection value from the sensor 27 being less than the predetermined value or the like (NO in S103), the controller 20 projects the correction image C for correcting the keystone distortion of the projection image PG as shown in FIG. 6 (S105).

The controller 20 may combine the projection image PG and the correction image C together in the memory 15 and project the combined image, as in the case of the notification image A described above.

For example, the controller 20 can superimpose the correction image C on the projection image PG subjected to the transmission processing, thus combine these images together, and project the combined image. At this time, the controller 20 may perform the reduction processing for reducing the visibility of the projection image PG. As described above, examples of the reduction processing include pixelization processing, luminance reduction processing, tone reduction processing, and the like.

In this way, the controller 20 can perform the reduction process of reducing the visibility on the projection image PG, which is a first image, to obtain a second image, and superimpose the correction image C on the second image.

The correction on the correction image C by the controller 20 is also a correction on the projection image PG to be superimposed.

The controller 20 may switch the target to be read from the memory 15 to the correction image C and project only the correction image C.

As described above, the controller 20 can calculate the first speed at which the housing 10 moves, the second speed faster than the first speed, and the like, based on the result of detection by the sensor 27.

As described above, the controller 20 can perform the following processing when performing the reduction processing of reducing the visibility of the projection image PG, which is the first image, so as to obtain the second image.

That is, the controller 20 can perform the reduction processing such that the visibility of the projection image PG when the speed is the first speed becomes lower than the visibility of the projection image PG when the speed is the second speed, based on the result of calculation of the speed of the housing 10 using the sensor 27.

The controller 20 strengthens the reduction processing as the speed at which the housing 10 moves becomes slower, and weakens the reduction processing as the speed at which the housing 10 moves becomes faster.

When the speed is the first speed, at which it is relatively easy for the image to catch the user's eye, the controller 20 can make the projection image PG changed by the correction less perceptible, and therefore can reduce the user's feeling that something is wrong.

Meanwhile, when the speed is the second speed, at which it is relatively difficult for the image to catch the user's eye, the controller 20 can make it difficult for the user to feel that something is wrong even if the projection image PG changed by the correction is easily perceptible. When the speed is the second speed, the controller 20 may stop the reduction processing.

It is difficult for the user to correct the keystone distortion of the projection image PG by changing the posture of the housing 10. Therefore, when the user stops changing the posture of the housing 10 and the housing 10 stops, the controller 20 performs the correction (S106).

The projection of the correction image C described above can also be said to be the processing of starting the correction by the controller 20. Hereinafter, the correction processing by the controller 20 will be described in detail.

As shown in FIG. 6, when correcting the keystone distortion, the controller 20 projects the correction image C on the projection surface SC.

The correction image C corresponds to the notification image A and is equivalent to the notification image A. That is, the correction image C includes a second message CM, which is a character string "correction in progress", a second guide pattern CG that is a rectangular frame, and a second background image CB.

The second message CM, the second guide pattern CG, and the second background image CB may be stored in the memory 15 as individual images and combined together as the correction image C by the controller 20.

In the memory 15, the notification image A may be stored in the nonvolatile memory, and the correction image C may be stored in the volatile memory in a rewritable manner. In this case, the controller 20 may first copy the notification image A in the nonvolatile memory to the volatile memory and then rewrite the notification image A into the correction image C according to a correction value, described later.

The correction image C can also be said to be the notification image A or the notification image A that is corrected and changed.

The correction image C includes "correction in progress" of the second message CM, which is a character string notifying that the geometric correction processing is not finished. The second message CM is preferably located at the center of the correction image C.

The user can visually recognize the character string "correction in progress", which is the second message CM of the correction image C, and recognize that the projection device 1 is in the state of "correction in progress" with respect to the projection image PG. The second guide pattern CG is preferably a rectangular frame including an area of a maximum range that can be projected by the projection device 1.

The gradation or the like of the second background image CB of the correction image C can be similar to that of the first background image AB of the notification image A described above.

In the second background image CB, the gradation becomes darker and the tint is blurred toward the center of the correction image C, and the gradation becomes lighter and the tint is blurred toward four corners CB1 to CB4. The four corners CB1 to CB4 of the second background image CB are a lower left corner CB1, an upper left corner CB2, an upper right corner CB3, and a lower right corner CB4. The four corners CB1 to CB4 are also the four corners of the correction image C and are also the four corners of the second guide pattern CG. The gradation may become lighter and the tint may be blurred toward the four sides of the second guide pattern CG representing a rectangle.

The gradation of the second background image CB is, for example, of a color such as red, green, or blue, and a single color is preferably used. The gradation may be of a color using gray tone including white. The second background image CB may be white without using gradation.

As will be described later, when the controller 20 corrects the correction image C, the correction image C is projected onto the projection surface SC while changing so as to reduce the keystone distortion. The user may visually recognize the correction image C that is automatically changed by the projection device 1 without being based on the user's own instruction or the like, and may feel that something is wrong.

Therefore, the projection device 1 changes the correction image C so as to avoid causing the user to feel that something is wrong, as much as possible.

For example, a change at the four corners or on the four sides of the correction image C is more noticeable to the user. Therefore, in the second background image CB of the correction image C, the gradation is lighter and the tint is more blurred toward the four corners or the four sides, and the change is thus made less noticeable.

In this way, the brightness of the second background image CB of the correction image C increases continuously or in stages in the direction toward the periphery. In this case, the user is less likely to feel that something is wrong than when the second background image CB has an edge or the like in the vicinity of the periphery.

Even when the projection image PG and the correction image C are combined together, the gradation of the correction image C makes the change in the projection image PG less noticeable as well as in the correction image C. When the second background image CB is white, the second background image CB is less noticeable.

Such a second background image CB can achieve an effect of preventing the user from feeling that something is wrong.

The second message CM at the center of the correction image C has a clear contrast difference from the second background image CB having a dark gradation, and is easily visually recognized by the user. When the second background image CB is white, the second message CM may be black or colored.

The user can visually recognize the projection of the correction image C and grasp that the state of the processing of correcting the keystone distortion of the projection image PG is "correction in progress", and this is convenient.

With the second message CM and the second background image CB, the convenience for the user can be improved and an effect of preventing the user from feeling that something is wrong can be achieved.

The controller 20 causes the camera 24 to pick up the correction image C projected on the projection surface SC, calculates the inclination of the housing 10, and corrects the correction image C such that the keystone distortion of the correction image C is reduced.

Assuming that the correction image C is based on the notification image A, the following can be said. That is, it can be said that the second message CM, the second guide pattern CG, the second background image CB, and the like included in the correction image C illustrated in FIG. 6 are the first message AM, the first guide pattern AG, the first background image AB, and the like included in the notification image A illustrated in FIG. 5 that are now being corrected or that are already corrected.

The correction of the keystone distortion as described above is referred to as so-called keystone correction. The keystone correction is an example of geometric correction. The geometric correction is also referred to as geometrical correction.

The keystone correction will be described in detail below. It is assumed that the positional relationship between the camera 24 and the projection lens 37 is known due to a calibration in advance. The controller 20 specifies a plurality of different positions in the second guide pattern CG of the correction image C picked up by the camera 24. The controller 20 measures the distances to the specified plurality of positions by triangulation. The camera 24 may pick up an image different from the correction image C, for example, a dot pattern. In this case, the controller 20 causes the camera 24 to pick up a dot pattern or the like instead of the correction image C, and measures the distance to the position of each dot by triangulation similarly to the above. The controller 20 causes the projector 30 to project the notification image A, the dot pattern, and the correction image C in this order.

The controller 20 can calculate the inclination of the housing 10 of the projection device 1 with respect to the projection surface SC, based on the measured distances. The controller 20 can calculate the correction value, based on the calculated inclination of the housing 10. The correction value is stored in the memory 15.

The controller 20 may detect a plurality of distances to the projection surface SC, using a TOF (time-of-flight) sensor instead of the camera 24, and calculate the inclination of the housing 10. In this case, the second guide pattern CG of the correction image C may be omitted.

When the controller 20 determines that the housing 10 is not inclined, the controller 20 may end the correction processing. In this case, the second guide pattern CG of the picked-up correction image C represents the original rectangle.

The controller 20 reads the correction value from the memory 15 and corrects the correction image C. For example, the controller 20 can correct the correction image C corresponding to the projection image PG distorted in a trapezoidal shape as shown in FIG. 5 such that the upper side and the lower side have the same length as shown in FIG. 6, using the correction value, and project the correction image C in the form of the original rectangle.

The controller 20 can pick up an image by the camera 24 while projecting the correction image C, calculate the correction value, and give a feedback to correct the correction image C.

When the projection image PG and the correction image C are combined together, the projection image PG, too, can be corrected along with the correction image C.

When performing the keystone correction, the controller 20 can also correct the variation in the luminance based on the relative position between the projection device 1 and the projection surface SC, and perform anti-aliasing processing, which is processing for smoothing the rough contour of the image.

The controller 20 can also control a lens drive motor (not shown) to adjust the focus, zoom, and the like of the projection lens 37.

When the correction is finished, the controller 20 erases the correction image C from the memory 15 (S107), projects only the projection image PG, and ends the processing.

Specifically, when the projection image PG and the correction image C are combined together in the memory 15, the controller 20 erases the correction image C. When only the correction image C is projected, the controller 20 may switch from the correction image C to the projection image PG. This switching is included in the above-described deletion of the correction image C.

As described above, the projection device 1 according to the embodiment includes the projector 30 that projects the projection image PG on the projection surface SC, the housing 10 that accommodates at least a part of the projector 30, the sensor 27 that detects a movement or stop of the housing 10, and one or a plurality of processors of the controller 20.

When the one or plurality of processors of the controller 20 determine that the housing 10 is moving, based on the result of detection by the sensor 27, the one or plurality of processors cause the projector 30 to project the notification image A notifying that the processing of geometric correction on the projection image PG is not finished.

As a result, the user can visually recognize the notification image A of the projection device 1 and easily grasp the state of the keystone distortion correction processing, and convenience is thus improved.

While the embodiments have been described in detail with reference to the drawings, the specific configurations are not limited to the embodiments, and may be changed, replaced, or deleted without departing from the spirit and scope of the disclosure.

What is claimed is:

1. A projection device comprising:
a projector configured to project an image on a projection surface;
a housing configured to accommodate at least a part of the projector;
a sensor configured to detect a movement or stop of the housing; and
one or a plurality of processors, wherein
the one or plurality of processors cause the projector to project a notification image notifying that processing of geometric correction on the image is not finished, when it is determined that the housing is moving, based on a result of detection by the sensor.

2. The projection device according to claim 1, wherein
the notification image includes a character string for notifying that the processing of the geometric correction is not finished.

3. The projection device according to claim 2, wherein
the one or plurality of processors execute:
accepting an operation of setting a type of language; and
changing a content of the character string according to the type of language set by the operation.

4. The projection device according to claim 1, wherein
the notification image is superimposed on a second image obtained by performing reduction processing of reducing visibility of a first image based on content image data supplied from an image supply device.

5. The projection device according to claim 4, wherein
the one or plurality of processors execute:
calculating a speed at which the housing moves, based on the result of detection by the sensor; and
performing, based on a result of calculation of the speed, the reduction processing such that the visibility of the first image when the speed is a first speed is lower than the visibility of the first image when the speed is a second speed higher than the first speed.

6. A method for controlling a projection device including a projector configured to project an image on a projection surface, a housing configured to accommodate at least a part of the projector, a sensor configured to detect a movement or stop of the housing, and one or a plurality of processors, the method comprising:
causing, by the one or plurality of processors, the projector to project a notification image notifying that processing of geometric correction on the image is not finished, when it is determined that the housing is moving, based on a result of detection by the sensor.
